(19) United States
(12) Patent Application Publication
(10) Pub. No.: US 2024/0289596 A1
(43) Pub. Date: Aug. 29, 2024

(54) Systems and Methods for Analysis of Home Telematics Using Generative AI

(71) Applicant: STATE FARM MUTUAL AUTOMOBILE INSURANCE COMPANY, Bloomington, IL (US)

(72) Inventors: Aaron Williams, Congerville, IL (US); Scott T. Christensen, Salem, OR (US); Ryan Gross, Normal, IL (US); Joseph P. Harr, Bloomington, IL (US)

(21) Appl. No.: 18/196,700

(22) Filed: May 12, 2023

Related U.S. Application Data
(60) Provisional application No. 63/460,676, filed on Apr. 20, 2023.
(60) Provisional application No. 63/453,607, filed on Mar. 21, 2023.
(60) Provisional application No. 63/450,228, filed on Mar. 6, 2023.
(60) Provisional application No. 63/447,987, filed on Feb. 24, 2023.

(51) Int. Cl. G06N 3/0475; G06Q 40/08

(52) U.S. Cl. CPC G06N 3/0475; G06Q 40/08

(57) ABSTRACT

Systems and methods are described for analyzing home telematics data to generate a dialogue output. The method may include: (1) receiving, by one or more processors, home telematics data at a generative artificial intelligence (AI) model, wherein the home telematics data includes sensor data regarding a property associated with a user; (2) analyzing, by the one or more processors and using the generative AI model, the home telematics data to generate a home telematics analysis for the property; and (3) generating, by the one or more processors and using the generative AI model, a dialogue output (or visual or virtual output for display) to present to the user based upon at least the home telematics analysis, wherein the dialogue output is further generated based upon at least a predicted user understanding of the dialogue output.

### CROSS-REFERENCE TO RELATED APPLICATIONS

This application claims priority to and the benefit of the filing date of provisional U.S. Patent Application No. 63/447,987 entitled “SYSTEMS AND METHODS FOR ANALYSIS OF HOME TELEMATICS USING GENERATIVE AI,” filed on Feb. 24, 2023; provisional U.S. Patent Application No. 63/450,228 entitled “SYSTEMS AND METHODS FOR ANALYSIS OF HOME TELEMATICS USING GENERATIVE AI,” filed on Mar. 6, 2023; provisional U.S. Patent Application No. 63/453,607 entitled “SYSTEMS AND METHODS FOR ANALYSIS OF HOME TELEMATICS USING GENERATIVE AI,” filed on Mar. 21, 2023; and provisional U.S. Patent Application No. 63/460,676 entitled “SYSTEMS AND METHODS FOR ANALYSIS OF HOME TELEMATICS USING GENERATIVE AI,” filed on Apr. 20, 2023. The entire contents of the provisional applications are hereby expressly incorporated herein by reference.

### FIELD OF THE DISCLOSURE

Systems and methods are disclosed for analyzing home telematics data, including at least sensor data for a property associated with a user, and generating an output dialogue for the user.

### BACKGROUND

Current systems for analyzing and accessing home telematics data may be cumbersome and/or difficult to understand for a user. For example, when making a recommendation to a user regarding a property, a system may simply generate the work product broadly without tailoring information to the property in question, which may cause resources to be wasted as unnecessary or incorrect information is provided to the user. Alternatively, the system may direct a user to a human element to answer particular questions associated with the property, which may cause additional difficulties and wasted resources based upon repeated information requirements, timing, miscommunication, misunderstanding, etc.

In addition, current systems for generating, developing, and presenting data to a user may not account for nuances in language and user interpretation. For example, current systems may generate data for the user, such as indications of potentially hazardous activity (e.g., a broken pipe, a short-circuited device, a break in, etc.), but may phrase the information to be confusing, misleading, etc. For instance, when generating an alert, a current system may provide an indication of the sensor in question (e.g., an indication of a sensor in the kitchen), but may not provide a context for where the sensor is located and/or what is causing the alert.

The systems and methods disclosed herein provide solutions to these problems and may provide solutions to the ineffectiveness, insecurities, difficulties, inefficiencies, encumbrances, and/or other drawbacks of conventional techniques.

### SUMMARY

The present embodiments may relate to, inter alia, accurately and efficiently identifying impact factors in internal data and generating output dialogue associated with such. Systems and methods that may generate work product based upon the impact factors in the internal data are also provided.

In one aspect, a computer-implemented method for analyzing home data may be provided. The method may be implemented via one or more local or remote processors, servers, sensors, transceivers, memory units, mobile devices, wearables, smart glasses, augmented reality glasses, virtual reality glasses, smart contacts, mixed or extended reality glasses or headsets, voice bots, chatbots, ChatGPT bots, ChatGPT-based bots, and/or other electronic or electrical components, which may be in wired or wireless communication with one another. For example, in one instance, the method may include: (1) receiving, by one or more processors, home telematics data at a generative artificial intelligence (AI) model, wherein the home telematics data includes sensor data regarding a property associated with a user; (2) analyzing, by the one or more processors and using the generative AI model, the home telematics data to generate a home telematics analysis for the property; and/or (3) generating, by the one or more processors and using the generative AI model, a dialogue output (or visual or virtual output for display) to present to the user based upon at least the home telematics analysis, wherein the dialogue output is further generated based upon at least a predicted user understanding of the dialogue output. The method may include additional, less, or alternate actions and functionality, including that discussed elsewhere herein.

For instance, the computer-implemented method may include: determining, by the one or more processors and based upon at least the home telematics analysis, a likelihood of an insurance event occurring; wherein the dialogue output includes at least one of (i) information related to the insurance event or (ii) one or more actions to address the insurance event. Further, the one or more actions may include at least one of: (i) one or more preventative actions to prevent the insurance event, (ii) one or more mitigating actions to mitigate damage associated with the insurance event, or (iii) one or more prescriptive actions to fix damage associated with the insurance event.

Moreover, analyzing the home telematics data may include: determining, by the one or more processors, a likelihood of user remembrance for one or more locations for sensor placement; and wherein generating the dialogue output may include: generating, by the one or more processors, one or more recommendations for sensor placement based upon at least the determined likelihood of user remembrance. Additionally or alternatively, analyzing the home telematics data may include: determining, by the one or more processors, a likelihood of user maintenance for one or more locations for sensor placement; and wherein generating the dialogue output may include: generating, by the one or more processors, one or more recommendations for sensor placement based upon at least the determined likelihood of user maintenance.

Further, the sensor data may include security system data associated with the property and wherein the dialogue output may include an alert regarding potential intruders. Additionally, analyzing the home telematics data may include: comparing, by the one or more processors, the home telematics data to historical home telematics data to detect a difference in behavior; and/or determining, by the one or more processors and based upon at least the detected difference in behavior, that unusual activity is occurring on the property; wherein generating the dialogue output is responsive to determining that unusual activity is occurring.

Moreover, the generative AI model may include at least one of: (i) an AI or machine learning (ML) chatbot or (ii) an AI or ML voice bot.

In another aspect, a computer system for analyzing home telematics data may be provided. The computer system may include one or more local or remote processors, servers, sensors, transceivers, memory units, mobile devices, wearables, smart glasses, augmented reality glasses, virtual reality glasses, smart contacts, mixed or extended reality glasses or headsets, voice bots, chatbots, ChatGPT bots, ChatGPT-based bots, and/or other electronic or electrical components, which may be in wired or wireless communication with one another. For example, the system may include one or more processors; a communication unit; and a non-transitory computer-readable medium coupled to the one or more processors and the communication unit and storing instructions thereon that, when executed by the one or more processors, cause the computing device to: (1) receive home telematics data at a generative artificial intelligence (AI) model, wherein the home telematics data includes sensor data regarding a property associated with a user; (2) analyze, using the generative AI model, the home telematics data to generate a home telematics analysis for the property; and/or (3) generate, using the generative AI model, a dialogue output (or visual or virtual output for display) to present to the user based upon at least the home telematics analysis, wherein the dialogue output is further generated based upon at least a predicted user understanding of the dialogue output. The computing device may include additional, less, or alternate functionality, including that discussed elsewhere herein.

In another aspect, a tangible, non-transitory computer-readable medium storing instructions for analyzing home telematics data may be provided. The non-transitory computer-readable medium stores instructions that, when executed by one or more processors of a computing device, cause the computing device to: (1) receive home telematics data at a generative artificial intelligence (AI) model, wherein the home telematics data includes sensor data regarding a property associated with a user; (2) analyze, using the generative AI model, the home telematics data to generate a home telematics analysis for the property; and/or (3) generate, using the generative AI model, a dialogue output (or visual or virtual output for display) to present to the user based upon at least the home telematics analysis, wherein the dialogue output is further generated based upon at least a predicted user understanding of the dialogue output. The computer-readable instructions may include instructions that provide additional, less, or alternate functionality, including that discussed elsewhere herein.

In another aspect, a computer-implemented method for analyzing home telematics data may be provided. The method may be implemented via one or more local or remote processors, servers, sensors, transceivers, memory units, mobile devices, wearables, smart glasses, augmented reality glasses, virtual reality glasses, smart contacts, mixed or extended reality glasses or headsets, chatbots, voice bots, ChatGPT bots, and/or other electronic or electrical components, which may be in wired or wireless communication with one another. For example, in one instance, the method may include: (1) receiving, by one or more processors, home telematics data at a machine learning (ML) model, wherein the home telematics data includes sensor data regarding a property associated with a user; (2) analyzing, by the one or more processors and using the ML model, the home telematics data to generate a home telematics analysis for the property; and/or (3) generating, by the one or more processors and using the ML model, a dialogue output (or visual or virtual output for display) to present to the user based upon at least the home telematics analysis, wherein the dialogue output is further generated based upon at least a predicted user understanding of the dialogue output. The method may include additional, less, or alternate actions and functionality, including that discussed elsewhere herein.

This summary is provided to introduce a selection of concepts in a simplified form that are further described in the Detailed Descriptions. This summary is not intended to identify key features or essential features of the claimed subject matter, nor is it intended to be used to limit the scope of the claimed subject matter.

Advantages will become more apparent to those of ordinary skill in the art from the following description of the preferred aspects, which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF THE DRAWINGS

FIG. 1 depicts an exemplary computer system that facilitates communication with data gathering at, and analysis via a generative device implementing a generative artificial intelligence and/or machine learning model.

FIG. 2A depicts an exemplary artificial intelligence and/or machine learning model to be implemented in a generative device as described with regard to FIG. 1.

FIG. 2B depicts an exemplary large language model to be implemented in a generative device as described with regard to FIG. 1.

FIG. 3 depicts an exemplary interface with which a user interacts with an intelligence and/or machine learning model in a generative device as described with regard to FIG. 1.

FIG. 4A depicts another exemplary interface with which a user interacts with an intelligence and/or machine learning model in a generative device as described with regard to FIG. 1.

FIG. 4B depicts an extension of the exemplary interface as described with regard to FIG. 4A including a generated visual output associated with the dialogue.

FIG. 5 depicts a flow diagram representing an exemplary computer-implemented method for using a generative artificial intelligence and/or machine learning model to analyze home telematics data.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Techniques, systems, apparatuses, components, devices, and methods are disclosed for, inter alia, analyzing data (e.g., home telematics data) using a generative artificial intelligence (AI) and/or machine learning (ML) model. For example, a system may receive sensor data, security system data, smart device data, etc. and generate a dialogue output regarding a property.

A generative AI may be used to analyze home data by receiving home telematics data and making determinations for user actions. For example, the AI may receive security system data to determine unusual behavior to identify potential intruders. Similarly, the AI may retrieve data to determine the best locations for sensor placement (e.g., where a user is most likely to remember or check, or where the sensor will collect the most useful data, such as at locations of potentially or most likely areas within a home that will receive various type of damage, such as water, mold, decay, smoke, fire, etc. damage). Moreover, the AI may determine a likelihood of various events occurring and relate the information to the user and/or how to address the events.

In some embodiments, the generative artificial intelligence (AI) models (also referred to as generative machine learning (ML) models) including voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed or used in conjunction with reinforced or reinforcement learning techniques. The voice or chatbot may employ the techniques utilized for ChatGPT. The voice bot, chatbot, ChatGPT-based bot, ChatGPT bot, and/or other such generative model may generate audible or verbal output, text or textual output, visual or graphical output, output for use with speakers and/or display screens, and/or other types of output for user and/or other computer or bot consumption.

Noted above, in some embodiments, a chatbot or other computing device may be configured to implement machine learning, such that server computing device “learns” to analyze, organize, and/or process data without being explicitly programmed. Machine learning may be implemented through machine learning (“ML”) methods and algorithms (“ML methods and algorithms”). In one exemplary embodiment, a machine learning module (“ML module”) may be configured to implement ML methods and algorithms.

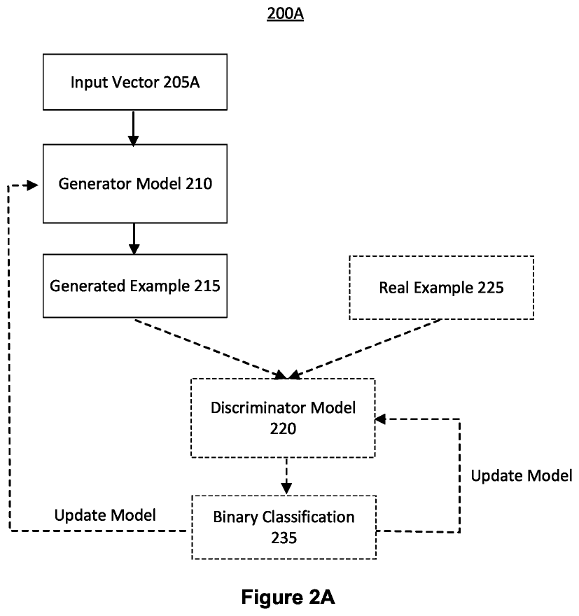

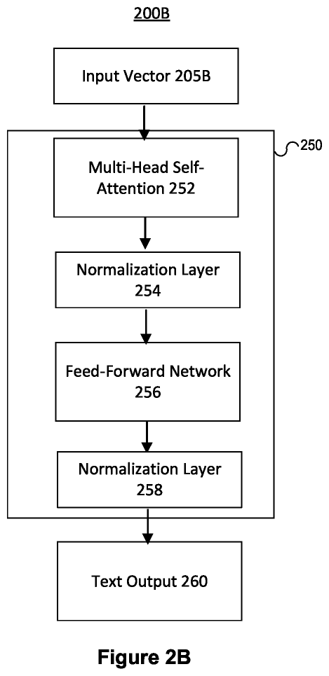

As used herein, a chat or voice bot (referred to broadly as “chatbot”) may refer to a specialized system for implementing, training, utilizing, and/or otherwise providing an AI or ML model to a user for dialogue interaction (e.g., “chatting”). Depending on the embodiment, the chatbot may utilize and/or be trained according to language models, such as natural language processing (NLP) models and/or large language models (LLMs). Similarly, the chatbot may utilize and/or be trained according to generative adversarial network techniques, as described in more detail below with regard to FIGS. 2A and 2B.

The chatbot may receive inputs from a user via text input, spoken input, gesture input, etc. The chatbot may then use AI and/or ML techniques as described herein to process and analyze the input before determining an output and displaying the output to the user. Depending on the embodiment, the output may be in a same or different form than the input (e.g., spoken, text, gestures, etc.), may include images, and/or may otherwise communicate the output to the user in an overarching dialogue format.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiment, a processing element may be trained by providing it with a large sample of data with known characteristics or features.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

### Exemplary Computer System for Detecting, Predicting, and/or Responding to Malfunctions in a Heating System

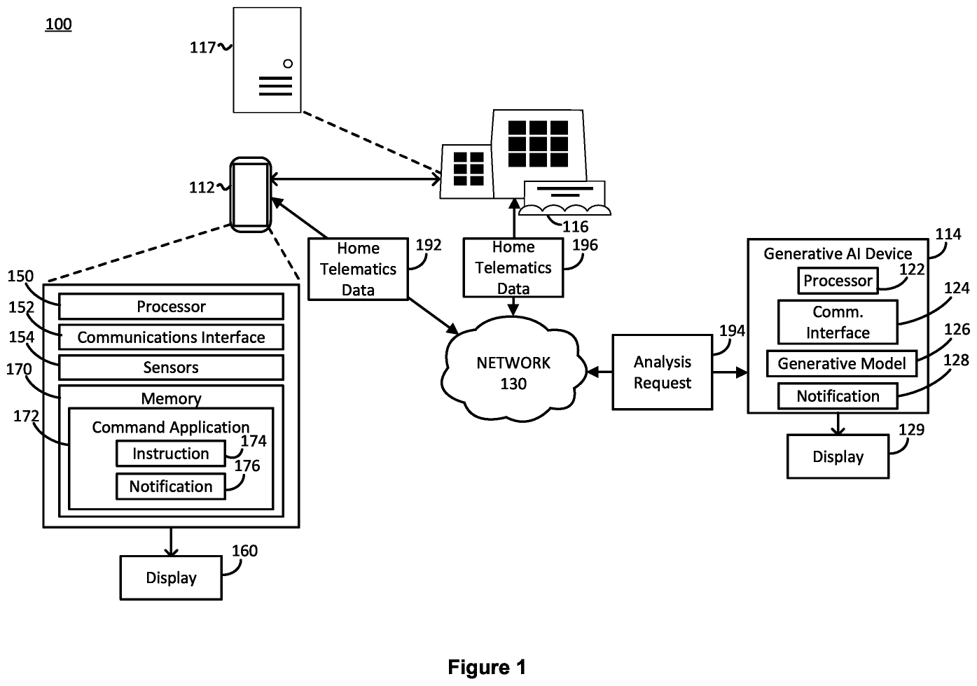

FIG. 1 depicts an exemplary computer system 100 for analyzing home telematics data to generate a personalized output via generative artificial intelligence (AI) and/or machine learning (ML) model(s), in accordance with various aspects of the present disclosure. An entity, such as a user or an insurance company, may wish to use a generative AI or ML model to determine how an individual will react to information, a project, a product, a PR (public relations) campaign, etc.

Depending on the embodiment, the exemplary computer system 100 may generate home telematics data for a property 116. Depending on the embodiment, the system 100 may generate and/or retrieve data from one or more sensors associated with the property 116 (e.g., motion sensors, moisture sensors, temperature sensors, smoke or fire sensor, etc.). Similarly, the system 100 may generate and/or retrieve data from one or more security systems associated with the property 116, one or more smart devices associated with the property 116, one or more mobile devices associated with a user and/or the property 116, etc.

Additionally, the property (e.g., property 116) and, more specifically, a computing device 117 associated with the property 116, a smart device within the property 116, and/or one or more mobile devices may detect, gather, or store home data (e.g., home telematics data) associated with the functioning, operation, and/or evaluation of the property 116. The computing device 117 associated with the property 116 may transmit home telematics data in a communication 196 via the network 130 to a generative AI device 114. In some embodiments, the generative AI device 114 may already store home data (e.g., home telematics data) and/or user data (e.g., user telematics data) in addition to any received home telematics data or user telematics data. Further, the generative AI device 114 may use the home telematics data and/or user telematics data to perform various functionalities associated with the user and/or the property 116 as described herein. Additionally or alternatively, one or more mobile devices (e.g., mobile device 112) communicatively coupled to the computing device associated with the property 116 may transmit home telematics data and/or user telematics data in communication 192 to the generative AI device 114 via the network 130.

The smart device may include a processor, a set of one or several sensors, and/or a communications interface. In some embodiments, the smart device may include single devices, such as a smart television, smart refrigerator, smart doorbell, or any other similar smart device. In further embodiments, the smart device may include a network of devices, such as a security system, a lighting system, or any other similar series of devices communicating with one another. The set of sensors may include, for example, a camera or series of cameras, a motion detector, a temperature sensor, an airflow sensor, a smoke detector, a carbon monoxide detector, or any similar sensor.

It is noted that the sensors need not be internal components of the smart device. Rather, a property 116 may include any number of sensors in various locations, and the smart device may receive data from these sensors during operation. In further embodiments, the computing device 117 associated with the property 116 may receive data from the sensors during operation. In still further embodiments, the computing device 117 associated with the property 116 may be the smart device. In some embodiments, the smart device may collect the home telematics data using the sensors. Depending on the embodiment, the smart device may collect home telematics data regarding the usage and/or occupancy of the property.

Moreover, the home telematics data may include user data from the user's mobile device, or other computing devices, such as smart glasses, wearables, smart watches, laptops, smart glasses, augmented reality glasses, virtual reality headsets, etc. The user data or user telematics data may include data associated with the movement of the user, such as GPS or other location data, and/or other sensor data, including camera data or images acquired via the mobile or other computing device. In some embodiments, the home telematics data may include historical data related to the property and/or property usage, such as historical home data, historical claim data, historical accident data, etc. In further embodiments, the home telematics data may include present and/or future data, such as expected occupancy data, projected claim data, projected accident data, etc. Depending on the embodiment, the historical home telematics data and the present and/or future data may be related. Additionally or alternatively, the home telematics data may include electric device usage data, electricity usage data, water usage date, electric meter data, water meter data, etc.

Depending on the embodiment, the home telematics data may be data directed to one or more systems associated with a property 116. For example, the home telematics data may be or include data associated with electricity flow in a house (e.g., an indication when flow is cut off to a portion of the house or the entire house), electricity supply to one or more devices in a surrounding area on a property, spikes or valleys in energy consumption, behavior and/or habit data associated with electricity usage (e.g., an indication that electricity usage is increased on weekdays from 6:00 PM to 10:00 PM), etc.

Similarly, the home telematics data may be or include data associated with water flow in a house (e.g., an indication when flow is cut off to a portion of the house or the entire house), spikes or valleys in water consumption, detected increased or decreased water present, potential flooding data, behavior and/or habit data associated with water usage, etc.

In some embodiments, the home telematics data may include data such as security camera data, electrical system data, plumbing data, appliance data, energy data, maintenance data, guest data, and any other suitable data representative of property 116. For instance, the home telematics data may include data gathered from motion sensors and/or images of the home from which it may be determined how many people occupy the property and the amount of time they each spend within the home. Additionally or alternatively, the home telematics data may include electricity usage data, water usage data, HVAC usage data (e.g., how often the furnace or air conditioner unit is on), and smart appliance data (e.g., how often the stove, oven, dish washer, or clothes washer is operated). The home telematics data may also include home occupant mobile device data or home guest mobile device data, such as GPS or other location data.

The home telematics data may also include home telematics data collected or otherwise generated by a home telematics app installed and/or running on the user's mobile device or other computing device. For instance, a home telematics app may be in communication with a smart home controller (e.g., for controlling a heating/HVAC system) and/or smart lights, smart appliances or other smart devices situated about a home, and may collect data from the interconnected smart devices and/or smart home sensors. Depending on the embodiment, the user telematics data and/or the home telematics data may include information input by the user at a computing device or at another device associated with the user. In further embodiments, the user telematics data and/or the home telematics data may only be collected or otherwise generated after receiving a confirmation from the user, although the user may not directly input the data.

Mobile device 112 may be associated with (e.g., in the possession of, configured to provide secure access to, etc.) a particular user, who may provide a response to an inquiry (e.g., a survey) and/or sensor data regarding a property, such as property 116. Mobile device 112 may be a personal computing device of that user, such as a mobile device, smartphone, a tablet, smart contacts, smart glasses, smart headset (e.g., augmented reality, virtual reality, or extended reality headset or glasses), smart watch, wearable, or any other suitable device or combination of devices (e.g., a smart watch plus a smartphone) with wireless communication capability. In the embodiment of FIG. 1, mobile device 112 may include a processor 150, a communications interface 152, sensors 154, a memory 170, and a display 160.

Processor 150 may include any suitable number of processors and/or processor types. Processor 150 may include one or more CPUs and one or more graphics processing units (GPUs), for example. Generally, processor 150 may be configured to execute software instructions stored in memory 170. Memory 170 may include one or more persistent memories (e.g., a hard drive and/or solid state memory) and may store one or more applications, including command application 172.

The mobile device 112 may be communicatively coupled to a computing device 117 associated with the property 116. For example, the mobile device 112 and computing device 117 associated with the property 116 may communicate via USB, Bluetooth, Wi-Fi Direct, Near Field Communication (NFC), etc. In other embodiments, mobile device 112 may obtain data from the property 116 from sensors 154 within the mobile device 112.

Further still, mobile device 112 may obtain the home telematics data via a user interaction with a display 160 of the mobile device 112. For example, a user may respond via the display 160 to a survey or interact with the generative device 114 via the display 160. The mobile device 112 may then generate a communication that may include the home telematics data.

Depending on the embodiment, a computing device 117 associated with the property 116 may obtain home telematics data for the property 116 indicative of sensor data, smart device data, security system data, etc. In other embodiments, the computing device 117 associated with the property 116 may obtain home telematics data through interfacing with a mobile device 112.

In some embodiments, the home telematics data may include interpretations of raw data, such as analysis of security system data. Also, in some embodiments, computing device 117 associated with the property 116 and/or mobile device 112 may generate and transmit communications periodically (e.g., every minute, every hour, every day), where each communication may include a different set of home telematics data collected over a most recent time period. In other embodiments, computing device 117 associated with the property 116 and/or mobile device 112 may generate and transmit communications as the mobile device 112 and/or computing device 117 associated with the property 116 receive new home telematics data.

In some embodiments, generating the communication 196 may include (i) obtaining identity data for the computing device 117 and/or the property 116; (ii) obtaining identity data for the mobile device 112 in the property 116; and/or (iii) augmenting the communication 196 with the identity data for the property 116, the computing device 117, and/or the mobile device 112. The communication 196 may include home telematics data.

In further embodiments, a generative device 114 may receive and/or transmit data related to an analysis request 194 via the network 130. Depending on the embodiment, the generative device may include one or more processors 122, a communications interface 124, a generative model module 126, a notification module 128, and a display 129. In some embodiments, each of the one or more processors 122, communications interface 124, generative model module 126, notification module 128, and display 129 may be similar to the components described above with regard to the mobile device 112.

The mobile device 112 and the computing device 117 associated with the property 116 may be associated with the same user. Mobile device 112, and optionally the computing device 117 associated with the property 116, may be communicatively coupled to generative device 114 via a network 130. Network 130 may be a single communication network, or may include multiple communication networks of one or more types (e.g., one or more wired and/or wireless local area networks (LANs), and/or one or more wired and/or wireless wide area networks (WANs) such as the internet). In some embodiments, the generative device 114 may connect to the network 130 via a communications interface 124 much like mobile device 112.

While FIG. 1 shows only one mobile device 112, it is understood that many different mobile devices (of different users), each similar to mobile device 112, may be in remote communication with network 130. Additionally, while FIG. 1 shows only one property 116 and associated computing device 117, it is understood that many properties, each similar to property 116, may include computing devices 117 that are in remote communication with network 130.

Further, while FIG. 1 shows only one generative device 114, it is understood that many different generative devices, each similar to generative device 114, may be in remote communication with network 130. Generative device 114 and/or any other similar generative device may be associated with an insurance company, a regulator organization, a property rental company, and/or a similar organization.

### Exemplary Machine Learning

Optionally, the system 100 may determine particular data using a machine learning (and/or artificial intelligence) model for data evaluation. The machine learning model may be trained based upon a plurality of sets of home telematics data, and corresponding determinations. The machine learning model may use the home telematics data to generate the determinations as described herein. In some embodiments, the machine learning model may be or include a generative AI or ML model as described with regard to FIGS. 2A and 2B. In further embodiments, the machine learning model may perform some determinations as described herein while others are performed by a generative AI or ML model as described with regard to FIGS. 2A and 2B.

Machine learning techniques have been developed that allow parametric or nonparametric statistical analysis of large quantities of data. Such machine learning techniques may be used to automatically identify relevant variables (i.e., variables having statistical significance or a sufficient degree of explanatory power) from data sets. This may include identifying relevant variables or estimating the effect of such variables that indicate actual observations in the data set. This may also include identifying latent variables not directly observed in the data, viz. variables inferred from the observed data points.

Some embodiments described herein may include automated machine learning to determine risk levels, identify relevant risk factors, evaluate home telematics data and/or home telematics data, identify environmental risk factors, identify locale-based risk factors, identify heating system risk factors, identify plumbing risk factors, and/or perform other functionality as described elsewhere herein.

Although the methods described elsewhere herein may not directly mention machine learning techniques, such methods may be read to include such machine learning for any determination or processing of data that may be accomplished using such techniques. In some embodiments, such machine-learning techniques may be implemented automatically upon occurrence of certain events or upon certain conditions being met. Use of machine learning techniques, as described herein, may begin with training a machine learning program, or such techniques may begin with a previously trained machine learning program.

A processor or a processing element may be trained using supervised or unsupervised machine learning, which may be followed by or used in conjunction with reinforced or reinforcement learning, and the machine learning program may employ a neural network, which may be a convolutional neural network, a deep learning neural network, or a combined learning module or program that learns in two or more fields or areas of interest. Machine learning may involve identifying and recognizing patterns in existing data (such as weather data, operation data, customer financial transaction, location, browsing or online activity, mobile device, vehicle, and/or home sensor data) in order to facilitate making predictions for subsequent customer data. Models may be created based upon example inputs of data in order to make valid and reliable predictions for novel inputs.

Additionally or alternatively, the machine learning programs may be trained by inputting sample data sets or certain data into the programs, such as mobile device, server, or home system sensor and/or control signal data, and other data discussed herein. The machine learning programs may utilize deep learning algorithms that are primarily focused on pattern recognition, and may be trained after processing multiple examples. The machine learning programs may include Bayesian program learning (BPL), voice recognition and synthesis, image or object recognition, optical character recognition, and/or natural language processing, either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct or a preferred output. In unsupervised machine learning, the processing element may be required to find its own structure in unlabeled example inputs. In one embodiment, machine learning techniques may be used to extract the control signals generated by computer systems or sensors, and under what conditions those control signals were generated. These techniques may be followed by reinforced or reinforcement learning techniques.

The machine learning programs may be trained with smart device-mounted, home-mounted, and/or mobile device-mounted sensor data to identify certain home telematics data, such as analyzing home telematics data and/or home telematics data to identify and/or determine environmental data, location data, first responder data, home structure data, occupancy data, usage data, water data, electricity data, water usage data, electricity usage data, a likelihood of pipe damage, and/or other such potentially relevant data. In some embodiments, the machine learning programs may be trained with irregularities such that the machine learning programs may be trained to match, compare, and/or otherwise identify impact factors based upon home telematics data. Depending on the embodiment, the machine learning programs may be initially trained according to such using example training data and/or may be trained while in operation using particular home telematics data.

After training, machine learning programs (or information generated by such machine learning programs) may be used to evaluate additional data. Such data may be related to publicly accessible data, such as building permits and/or chain of title. Other data may be related to privately-held data, such as insurance and/or claims information related to the property and/or items associated with the property. The trained machine learning programs (or programs utilizing models, parameters, or other data produced through the training process) may then be used for determining, assessing, analyzing, predicting, estimating, evaluating, or otherwise processing new data not included in the training data. Such trained machine learning programs may, therefore, be used to perform part or all of the analytical functions of the methods described elsewhere herein.

It will be understood that the above disclosure is one example and does not necessarily describe every possible embodiment. As such, it will be further understood that alternate embodiments may include fewer, alternate, and/or additional steps or elements.

### Exemplary Systems for Detecting and Responding to Heating System Malfunctions

FIG. 2A illustrates an exemplary model 200A using generative AI and/or ML techniques. In particular, a generator model 210 and a discriminator model 220 receive inputs to generate a binary classification 235 and output text used to analyze internal entity data.

In particular, the generator model 210 receives an input vector 205A to generate a generated example 215. In some embodiments, the input vector 205A may be a fixed-length random vector. In further embodiments, the input vector 205A may be drawn randomly from a Gaussian distribution such that points in the vector space corresponding to the input vector 205A may correspond to points in the problem domain representative of the data distribution. Depending on the embodiment, the vector space corresponding to the input vector 205A may include one or more hidden variables (e.g., variables that are not directly observable). In some embodiments, the input vector 205A may be used to seed the generative process. Using the input vector 205A, the generator model 210 then generates a generated example 215.

In some embodiments, the discriminator model 220 may then receive the generated example 215 and/or a real example 225. The discriminator model 220 may generate a binary classification 235 denoting whether the received input is generated (e.g., the generated example 215) or real (e.g., the real example 225). The exemplary model 200A may additionally output an output product (e.g., dialogue, textual output, visual output, etc.) and/or use the binary classification 235 in training the generator model 210 and/or discriminator model 220.

In further embodiments, the generator model 210 and the discriminator model 220 may receive additional inputs and/or information, such as a class value, a class label, modality data, etc. In some such embodiments, the additional information may function similarly to supervised machine learning techniques, and embodiments without the additional information may function similarly to unsupervised machine learning techniques.

In still further embodiments, the exemplary model 200A may use both the generator model 210 and the discriminator model 220 for training and may subsequently use only the generator model 210 for generative modeling as described herein.

In some embodiments, the generator model 210 and the discriminator model 220 are trained according to adversarial techniques (e.g., when the discriminator model 220 correctly generates the binary classification 235, the generator model 210 is updated and, when the discriminator model 220 incorrectly generates the binary classification 235, the discriminator model 220 is updated).

Depending on the embodiment, the generator model 210 and/or the discriminator model 220 may be or include neural networks, such as artificial neural networks (ANN), convolution neural networks (CNN), or recurrent neural networks (RNN). In further embodiments, the model 200A, the generator model 210, and/or the discriminator model 220 may incorporate, include, be, and/or otherwise use language model techniques (e.g., a large language model (LLM), natural language processing (NLP), etc.). Similarly, the model 200A, the generator model 210, and/or the discriminator model 220 may incorporate, include, be, and/or otherwise use a transformer architecture to utilize the appropriate language model techniques, as described with regard to FIG. 2B below.

FIG. 2B illustrates an exemplary large language model 200B for training a generative model as described herein. In particular, a large language training module 250 receives an input vector 205B similar to input vector 205A and outputs a text output 260.

In particular, in some embodiments, the generative AI and/or ML model may be based upon an LLM trained to predict a word in a sequence of words. For example, the LLM may be trained to predict a next word following a given sequence of words (e.g., “next-token-prediction”), and/or trained to predict a “masked” (e.g., hidden) word within a sequence of given sequence of words (e.g., “masked-language-modeling”). For instance, in an example of next-token-prediction, the generative AI and/or ML model may be given the sequence “Jane is a”—and the generative AI and/or ML model may predict a next word, such as “dentist,” “teacher,” “mother,” etc. In one example of masked-language-modeling, the generative AI and/or ML model may receive the given the sequence “Jane XYZ skiing”—and the generative AI and/or ML model may fill in XYZ with “loves,” “fears,” “enjoys,” etc.

In some embodiments, this prediction technique is accomplished through a long-short-term-memory (LSTM) model, which may fill in the blank with the most statistically probable word based upon surrounding context. However, the LSTM model has the following two drawbacks. First, the LSTM model does not rate/value individual surrounding words more than others. For instance, in the masked-language-modeling example of the preceding paragraph, skiing may most often be associated with “enjoys;” however Jane in particular may fear skiing but the LSTM model is not able to correctly determine this. Second, instead of being processed as a whole, the words of the input sequence are processed individually and sequentially, thus restricting the complexity of the relationships that may be inferred between words and their meanings.

Advantageously, some embodiments overcome these drawbacks of the LSTM model by using transformers (e.g., by using a generative pre-trained transformer (GPT) model). More specifically, some embodiments use a GPT model that includes (i) an encoder that processes the input sequence, and (ii) a decoder that generates the output sequence. The encoder and decoder may both include a multi-head self-attention mechanism that allows the GPT model to differentially weight parts of the input sequence to infer meaning and context. In addition, the encoder may leverage masked-language-modeling to understand relationships between words and produce improved responses.

In particular, the input vector 205B may be a vector representative of relationships between words, phrases, etc. in the input. The large language training module 250 may include a self-attention block 252 component to attend to different parts of the input simultaneously or near-simultaneously to capture relationships and/or dependencies between the different parts of the input (e.g., referred to as a multi self-attention block, multi-head attention block, multi-head self-attention block, masked multi self-attention block, masked multi-head attention block, masked multi-head self-attention block, etc.). In particular, the self-attention block 252 relates different positions of a sequence to compute a representation of the sequence. As such, the self-attention block 252 may weigh an impact of different words in a sentence when sequencing. As such, the model 200B learns to give emphasis to different portions of an input vector 205B. Depending on the implementation, the self-attention block 252 may transform the input vector 205B into different sets (e.g., queries, keys, values, etc.). In some implementations, the self-attention block 252 may receive the input vector 205B already-transformed. The self-attention block 252 may then compute an attention score representing the impact of each word in the sentence with respect to the other words in the sentence (e.g., by taking a dot product between different vector sets). The output then proceeds to the normalization layer 254.

The normalization layer 254 may normalize the output of the self-attention block 252 (e.g., by applying a softmax function to normalize the scores).

Similarly, the self-attention block may subsequently output into a feed-forward network block 256, which performs a non-linear transformation to generate a new representation of the input and/or relationships between words, phrases, etc. In particular, the feed-forward network block 256 may compute a weighted sum of the vectors, using the calculated and normalized attention scores to capture the contextual relationships between words. In some implementations, the normalization layer 254 and/or the self-attention block 252 may perform the computation to generate a representation of the relationship between words, etc. After the feed-forward network block 256, an additional normalization layer 258 may normalize the respective output and/or add residual connection(s) to allow the output to move directly to another input. The model 200B may therefore learn which parts of an input are important (e.g., remain prevalent through the normalization process). Depending on the embodiment, the model 200B may repeat the process for the large language training module 250 1 time, 5 times, 10 times, N times, etc. to train the respective model(s).

Depending on the implementation, an encoder and/or a decoder may be trained as described above. In further implementations, the encoder is trained in accordance with the above, and a decoder includes an additional self-attention block (not shown) receiving the output of the encoder as well.

Furthermore, in some embodiments, rather than performing the previous four steps only once, the GPT model iterates the steps and performs them in parallel; at each iteration, new linear projection of the query, key, and value vectors are generated. Such iterative, parallel embodiments advantageously improve grasping of sub-meanings and more complex relationships within the input sequence data.

Further advantageously, some embodiments first train a basic model (e.g., a basic GPT model, etc.), and subsequently perform any of the following three steps on the basic model: supervised fine tuning (SFT); reward modeling; and/or reinforcement learning.

In the SFT step, a supervised training dataset is created. The supervised training dataset has known outputs for each input so that the model can learn from the correspondences between input and outputs. For example, to train the model to generate summary documents, the supervised training dataset may have: (a) inputs of (i) insurance company application (app) information, (ii) anonymized insurance claim information, (iii) police report information, and/or (iv) auxiliary information; and (b) outputs of summary documents.

In another example, to train the model to generate comparison documents, the supervised training dataset may have: (a) inputs of (i) summary documents, (ii) insurance company application (app) information, (iii) anonymized insurance claim information, (iv) police report information, and/or (v) auxiliary information; and (b) outputs of comparison documents.

In yet another example, to train the model to generate requests for information, the supervised training dataset may have: (a) inputs of indications of missing information (e.g., an administrator contacts the chatbot with the question “please draft an email requesting a police report corresponding to insurance claim XYZ”), and (b) outputs of requests for information (e.g., in the form of a draft email or other message to send to an administrator of the police reports database, or an email or other message that the chatbot sends directly to the administrator of the police reports database, etc.).

Training the basic model on the supervised training dataset may create the SFT model; and subsequent to creating the SFT model, the generative AI and/or ML model may be trained according to reward modeling. In reward modeling, the SFT may be fed input prompts, and may output multiple outputs (e.g., 2-10 outputs, etc.) for each input. The multiple outputs for each input may be achieved by, for example, randomness, or by controlling a predictability setting. A user may then rank the multiple outputs for each input, thus allowing the model to associate each output with a reward (e.g., a scalar value). And the ranked outputs may then be used to further train the SFT model. Similarly, the reward modeling may be performed as otherwise described herein.

Subsequently, the generative AI and/or ML model may further be trained via reinforcement learning. Here, further inputs are fed into the model, and the model then generates, based upon the policy learned during reward modeling, (i) outputs corresponding to the inputs, and (ii) rewards values (e.g., scalar values) corresponding to the input/output pairs. The rewards values may then be fed back into the model to further evolve the policy.

In some embodiments, the reward modeling and reinforcement learning steps may be iterated any number of times.

It will be understood that the above disclosure is one example and does not necessarily describe every possible embodiment. As such, it will be further understood that alternate embodiments may include fewer, alternate, and/or additional steps or elements.

### Exemplary Generative AI/ML Model Exchange Applications and Interfaces

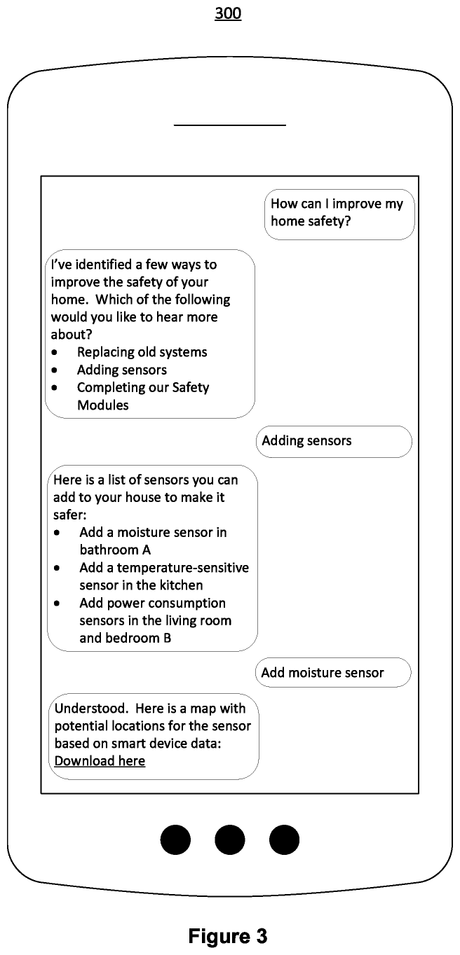

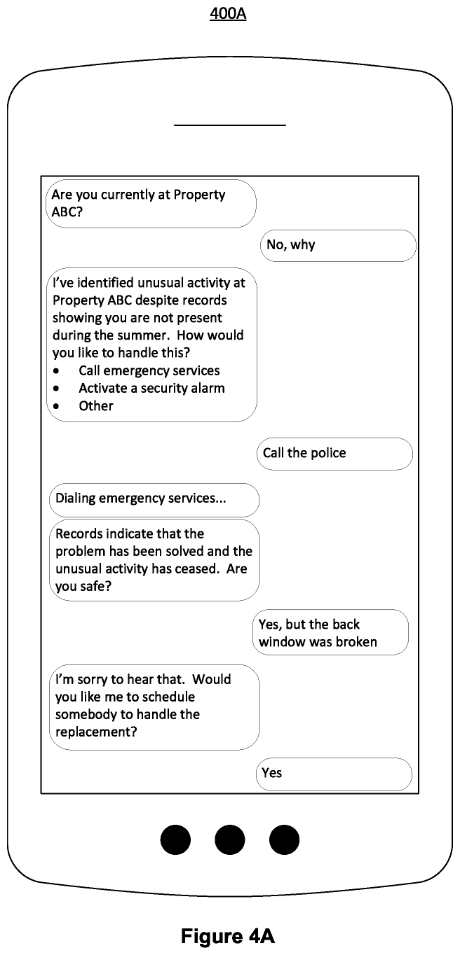

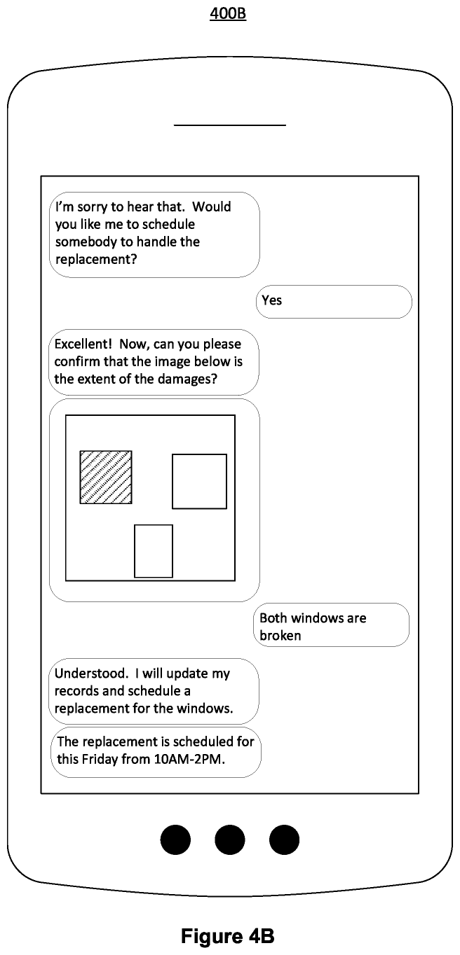

FIGS. 3-4B illustrate exemplary interfaces for communicating with a generative AI and/or ML model. In particular, FIG. 3 illustrates an interface 300 that displays an exchange between a user and the generative AI and/or ML model. In particular, a user requests that the generative AI and/or ML model provide recommendations for improving the safety of a property (e.g., property 116). The generative AI and/or ML model may use a designated property ID, a property associated with a user, an identifying factor of the property (e.g., an address, general location (the Florida property), a type of property (e.g., the beachfront property)), and/or any other such identifiable information. Although FIG. 3 depicts such a process with regard to improving property safety, it will be understood that an interface 300 may respond to similar queries and/or requests as otherwise detailed herein.

In some embodiments, the user starts the interaction by issuing a request to the generative AI and/or ML model. For example, in the exemplary interface 300, the user requests that the generative AI and/or ML model provide recommendations for improving a property safety level. Depending on the embodiment, the generative AI and/or ML model may determine that details regarding improving the safety of a property would be useful for a user without prompting (e.g., in response to an incident in the property, in response to a user requesting methods for reducing an insurance premium, in response to a user requesting a repair and/or replacement specialist, etc.). In further embodiments, the user may prompt the generative AI and/or ML model with a spoken command rather than a text command.

The generative AI and/or ML model may then prepare one or more broad recommendations from which the user may select. Depending on the embodiment, the generative AI and/or ML model may provide a list of categories, a list of links to particular information, a contact number to speak with a representative, etc. Depending on the embodiment, the generative AI and/or ML model may provide general improvements, an analyzed and/or curated version of the recommendations, recommendations related to a specific request, etc.

The user may then respond with a selection from the list, at which point the generative AI and/or ML model may generate further branches describing particular courses of action. In some embodiments, the generative AI and/or ML model may provide a map and/or model of the property based upon property data, the dialogue context, etc. Depending on the embodiment, such a map and/or model may be directly provided (e.g., in a chat window) and/or may be a link to the map and/or model.

It will further be understood that the above disclosure is one example and does not necessarily describe every possible embodiment. As such, it will be further understood that alternate embodiments may include fewer, alternate, and/or additional steps or elements.

FIGS. 4A and 4B illustrate interfaces 400A and 400B that display a warning to a user of a potential break in on a property, options for responding to the break in, and options for help in damage control in the aftermath. Depending on the embodiment, the exemplary interfaces 400A and 400B may resemble the exemplary interface 300 of FIG. 3, and relevant embodiments may similarly apply to FIGS. 4A and 4B.

In some embodiments, the generative AI and/or ML model may determine, based upon data regarding a property, whether unexpected activity is occurring (e.g., unexpected power usage, unexpected water usage, security systems, etc.). In response to detecting such activity, the generative AI and/or ML model may prompt the user to determine whether the user is at the property and/or may take action depending on one or more user preferences. The generative AI and/or ML model may then provide various options for the user to take and/or may receive an input from the user that causes the generative AI and/or ML model to take a particular action.

The generative AI and/or ML model may check in with the user after detecting that the incident is over to determine safety of the user and of the property. The user may provide information related to the user and/or the property (e.g., indicating that a window was broken by an intruder). The generative AI and/or ML model may then propose a course of action to address any potential damage (e.g., scheduling a repair).

Further, the generative AI and/or ML model may generate a visual representation of information the user provides to the generative AI and/or ML model regarding the incident. For example, in the exemplary embodiment of FIG. 4B, the generative AI and/or ML model prepares and presents a visual representation of the damage to the property. The generative AI and/or ML model may modify the information based upon feedback from the user and/or from one or more sensors or smart devices on the property.

The generative AI and/or ML model may then organize and/or schedule a response to any damage according to sensors associated with the property, a user device, a calendar for the user, price preferences for the user, etc.

It will further be understood that the above disclosure is one example and does not necessarily describe every possible embodiment. As such, it will be further understood that alternate embodiments may include fewer, alternate, and/or additional steps or elements.

### Exemplary Computer-Implemented Method for Using a Generative Model to Analyze Home Telematics Data

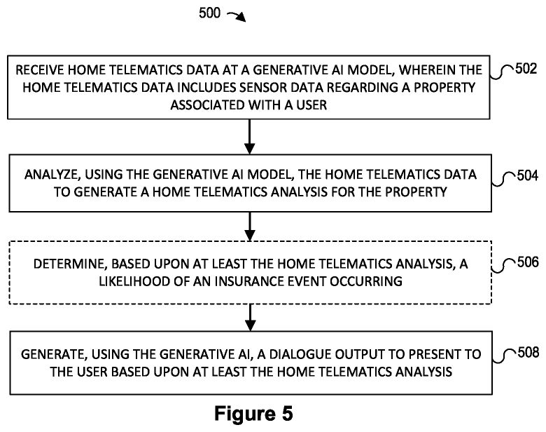

FIG. 5 is a flow diagram of an exemplary computer-implemented method 500 for analyzing home telematics data. The method 500 may be implemented by one or more processors of a computing system such as a computing device representing property 116 or mobile device 112. Alternatively or additionally, the method 500 may be implemented by one or more processors of a distributed system such as system 100 and/or various components of system 100 as described with regard to FIGS. 1 and/or 2 above, or otherwise implemented by one or more local or remote processors, servers, sensors, transceivers, memory units, wearables, smart contacts, smart glasses, virtual reality headsets, augmented reality glasses or headsets, mixed or extended reality headsets or glasses, voice or chat bots, generative AI, and/or other electronic or electrical components, including those mentioned elsewhere herein.

At block 502, the generative AI or ML model may receive home telematics data at a generative AI or ML model, wherein the home telematics data includes sensor data regarding a property associated with a user (e.g., water flow in pipes associated with the property, power flow to devices associated with the property, security sensors associated with the property, etc.). Depending on the embodiment, the home telematics data may additionally or alternatively include data from one or more smart devices, data supplied by the user regarding the property (e.g., from a mobile computing device as described above with regard to FIG. 1), publicly accessible data regarding the property (e.g., title, acreage, etc.), etc.

Depending on the embodiment, the home telematics data may further include any of location data, environment data, first responder data, home structure data, adherence to local construction codes, average power consumption, average water consumption, security data, occupancy data, detected hazards, predicted hazards, alarm data, or any other similarly suitable data regarding a property.

At block 504, the generative AI or ML model may analyze, using the generative AI model, the home telematics data to generate a home telematics analysis for the property. In some embodiments, analyzing the home telematics data may include determining a likelihood of user remembrance for one or more locations for recommended sensor placement. Similarly, analyzing the home telematics data may include determining a likelihood of user maintenance for one or more locations for recommended sensor placement.

For example, in some such embodiments, the generative AI or ML model determines the frequency with which a user walks through a particular portion of a property. Depending on the embodiment, the generative AI or ML model may determine the frequency based upon smart device data (e.g., the user opens a smart refrigerator between 6 AM and 7 AM daily), sensor data (e.g., water flows to a shower between 5 AM and 6 AM daily), motion or security data (e.g., a security alarm is primed at approximately 7:30 AM daily and deactivated at approximately 6:30 PM daily), etc. Based upon such, the generative AI or ML model may determine a general path through the property the user takes, areas which the user visits frequently, areas which the user visits rarely, etc. Depending on the embodiment, the generative AI or ML model may determine that such paths vary depending on time, day, month, season, etc.

In further embodiments, analyzing the home telematics data may include comparing the home telematics data to historical home telematics data to detect a difference in behavior (e.g., of sensors, owners, occupants, water usage, home occupancy, number of occupants, electricity usage, door usage, garage door usage, window usage (e.g., opening and closing), etc.) and determining, based upon the detected difference in behavior, that unusual activity is occurring on the property. For example, the generative AI or ML model may determine that, because a front door is opened at a time where the user would not normally open the door (e.g., 2 AM), unusual activity is occurring, regardless of whether other measures (e.g., security alarms) activate. As such, the generative AI or ML model may alert the user as described herein.

In some embodiments, the generative AI or ML mode receives larger quantities and/or ranges of home telematics data directly from a user (e.g., via a mobile device, computing device associated with the property, etc.) and determines what data is useful or relevant to a user query before discarding unimportant data. In further embodiments, the generative AI or ML model instead stores all received data and uses, sorts, or otherwise applies the data as needed.

At block 506, the generative AI or ML model may determine, based upon at least the home telematics analysis, a likelihood of an insurance event occurring. Depending on the embodiment, the insurance event may include damage to a property, theft of items on a property, failure of a component of a property, etc. In some embodiments, the generative AI or ML model may determine the likelihood of an insurance event based upon historical data associated with the property, current data associated with a user, data associated with similar properties (e.g., with similar sizes, in similar locations, with similar architectural styles, etc.), and/or according to any other such metric.

Depending on the embodiment, the generative AI or ML model may determine the likelihood of loss as part of or as the likelihood of an insurance event. In particular, the generative AI or ML model may determine a likelihood of loss associated with the property based upon claims data in the home telematics data, such as type of claim, cost of claim, cause of the claim, confirmation of fault, liability amount paid out, property damage paid out, freeform data (need to understand that from a data perspective, so needs other processing), coverage is paid, catastrophe, bodily injury, repair costs, estimated values for items damaged, prior damage, claim subrogation status, location of loss, date of loss, time of loss, date the claim was reported, etc.

At block 508, the generative AI or ML model may generate, using the generative AI, a dialogue output to present to the user based upon at least the home telematics analysis. In embodiments in which the generative AI or ML model determines the likelihood of an insurance event occurring, the dialogue output may further be based upon the insurance event and/or likelihood of the insurance event. In some embodiments, the dialogue output is generated based upon at least a predicted user understanding of the dialogue output. For example, the generative AI or ML model may generate the dialogue output such that the user is predicted to more easily understand the dialogue, is more likely to retain the information in the dialogue, is more likely to review the dialogue, etc.

In further embodiments, the dialogue output may include information related to an insurance event, actions to address an insurance event, etc. The actions may include mitigating actions to mitigate damage, preventative actions to prevent damage, prescriptive actions to fix damage, etc. Similarly, the dialogue output may include one or more recommendations for sensor placement based upon a determined likelihood of user remembrance or maintenance.

In still further embodiments, the dialogue output may include recommendations regarding sensors and/or systems in a property. For example, the dialogue output may include recommendations regarding types of sensors to add, locations to add or move sensors, sensors that should be updated or have maintenance performed, updates to security, alerts regarding potential intruders, etc. In some embodiments, the dialogue output may be generated in response to determining that unusual activity is occurring and/or has occurred.

Depending on the embodiment, the dialogue output may include a personalized discount for a charge (e.g., an insurance premium) based upon the home telematics data and/or based upon user data. In still further embodiments, the personalized dialogue output may include one or more visuals (e.g., text or graphics), one or more audio cues (e.g., a vocal answer to the user's question), etc. In some embodiments, the one or more visuals include one or more products that the generative AI or ML model determines would benefit the user.

In further embodiments, the method 500 may further include determining whether the user has a tendency to make good decisions and offer dialogue output based upon such. For example, the dialogue output may include advice, potential products to help with common problems, recommended learning modules, a discount based upon good decision making, etc.

### Additional Considerations

It will be understood that the above disclosure is one example and does not necessarily describe every possible embodiment. As such, it will be further understood that alternate embodiments may include fewer, alternate, and/or additional steps or elements.

With the foregoing, a user may opt-in to a rewards, insurance discount, or other type of program. After the user provides their affirmative consent, an insurance provider remote server may collect data from the user's mobile device, smart home device, smart vehicle, wearables, smart glasses, smart contacts, smart watch, augmented reality glasses, virtual reality headset, mixed or extended reality headset or glasses, voice or chat bots, ChatGPT bots, and/or other smart devices—such as with the customer's permission or affirmative consent. The data collected may be related to smart home functionality, accident data, and/or insured assets before (and/or after) an insurance-related event, including those events discussed elsewhere herein. In return, risk averse insureds, home owners, or home or apartment occupants may receive discounts or insurance cost savings related to home, renters, auto, personal articles, and other types of insurance from the insurance provider.

In one aspect, smart or interconnected home data, user data, and/or other data, including the types of data discussed elsewhere herein, may be collected or received by an insurance provider remote server, such as via direct or indirect wireless communication or data transmission from a smart home device, mobile device, smart vehicle, wearable, smart glasses, smart contacts, smart watch, augmented reality glasses, virtual reality headset, mixed or extended reality glasses or headset, voice bot, chat bot, ChatGPT bot, and/or other customer computing device, after a customer affirmatively consents or otherwise opts-in to an insurance discount, reward, or other program. The insurance provider may then analyze the data received with the customer's permission to provide benefits to the customer. As a result, risk averse customers may receive insurance discounts or other insurance cost savings based upon data that reflects low risk behavior and/or technology that mitigates or prevents risk to (i) insured assets, such as homes, personal belongings, vehicles, or renter belongings, and/or (ii) home or apartment renters and/or occupants.

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing.” “calculating.” “determining.” “presenting.” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes.” “including.” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

In addition, use of “a” or “an” is employed to describe elements and components of the embodiments herein. This is done merely for convenience and to give a general sense of the invention. This description should be read to include one or at least one and the singular also may include the plural unless it is obvious that it is meant otherwise.

Upon reading this disclosure, those of skill in the art will appreciate still additional alternative structural and functional designs for providing feedback to owners of properties, through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality and improve the functioning of conventional computers.

What is claimed:

1. A computer-implemented method for analyzing home telematics data and generating a dialogue output, the computer-implemented method comprising:
receiving, by one or more processors, home telematics data at a generative artificial intelligence (AI) model, wherein the home telematics data includes sensor data regarding a property associated with a user;
analyzing, by the one or more processors and using the generative AI model, the home telematics data to generate a home telematics analysis for the property; and
generating, by the one or more processors and using the generative AI model, a dialogue output to present to the user based upon at least the home telematics analysis, wherein the dialogue output is further generated based upon at least a predicted user understanding of the dialogue output.

2. The computer-implemented method of claim 1, the method further comprising:
determining, by the one or more processors and based upon at least the home telematics analysis, a likelihood of an insurance event occurring;
wherein the dialogue output includes at least one of (i) information related to the insurance event or (ii) one or more actions to address the insurance event.

3. The computer-implemented method of claim 2, wherein the one or more actions include at least one of: (i) one or more preventative actions to prevent the insurance event, (ii) one or more mitigating actions to mitigate damage associated with the insurance event, or (iii) one or more prescriptive actions to fix damage associated with the insurance event.

4. The computer-implemented method of claim 1, wherein analyzing the home telematics data includes:
determining, by the one or more processors, a likelihood of user remembrance for one or more locations for sensor placement; and
wherein generating the dialogue output includes:
generating, by the one or more processors, one or more recommendations for sensor placement based upon at least the determined likelihood of user remembrance.

5. The computer-implemented method of claim 1, wherein analyzing the home telematics data includes:
determining, by the one or more processors, a likelihood of user maintenance for one or more locations for sensor placement; and
wherein generating the dialogue output includes:
generating, by the one or more processors, one or more recommendations for sensor placement based upon at least the determined likelihood of user maintenance.

6. The computer-implemented method of claim 1, wherein the sensor data includes security system data associated with the property and wherein the dialogue output includes an alert regarding potential intruders.

7. The computer-implemented method of claim 6, wherein analyzing the home telematics data includes:
comparing, by the one or more processors, the home telematics data to historical home telematics data to detect a difference in behavior; and
determining, by the one or more processors and based upon at least the detected difference in behavior, that unusual activity is occurring on the property;
wherein generating the dialogue output is responsive to determining that unusual activity is occurring.

8. The computer-implemented method of claim 1, wherein the generative AI model includes at least one of: (i) an AI or machine learning (ML) chatbot or (ii) an AI or ML voice bot.

9. A computer system for analyzing home telematics data, the computer system comprising:
one or more processors;
a communication unit; and
a non-transitory computer-readable medium coupled to the one or more processors and the communication unit and storing instructions thereon that, when executed by the one or more processors, cause the computer system to:
receive home telematics data at a generative artificial intelligence (AI) model, wherein the home telematics data includes sensor data regarding a property associated with a user;
analyze, using the generative AI model, the home telematics data to generate a home telematics analysis for the property; and
generate, using the generative AI model, a dialogue output to present to the user based upon at least the home telematics analysis, wherein the dialogue output is further generated based upon at least a predicted user understanding of the dialogue output.

10. The computer system of claim 9, wherein the non-transitory computer-readable medium further stores instructions that, when executed by the one or more processors, cause the computer system to:
determine, based upon at least the home telematics analysis, a likelihood of an insurance event occurring;
wherein the dialogue output includes at least one of (i) information related to the insurance event or (ii) one or more actions to address the insurance event.

11. The computer system of claim 10, wherein the one or more actions include at least one of: (i) one or more preventative actions to prevent the insurance event, (ii) one or more mitigating actions to mitigate damage associated with the insurance event, or (iii) one or more prescriptive actions to fix damage associated with the insurance event.

12. The computer system of claim 9, wherein analyzing the home telematics data includes:
determining a likelihood of user remembrance for one or more locations for sensor placement; and
wherein generating the dialogue output includes:
generating one or more recommendations for sensor placement based upon at least the determined likelihood of user remembrance.

13. The computer system of claim 9, wherein analyzing the home telematics data includes:
determining a likelihood of user maintenance for one or more locations for sensor placement; and
wherein generating the dialogue output includes:
generating one or more recommendations for sensor placement based upon at least the determined likelihood of user maintenance.

14. The computer system of claim 9, wherein the sensor data includes security system data associated with the property and wherein the dialogue output includes an alert regarding potential intruders.

15. The computer system of claim 14, wherein analyzing the home telematics data includes:
comparing the home telematics data to historical home telematics data to detect a difference in behavior; and
determining, based upon at least the detected difference in behavior, that unusual activity is occurring on the property;
wherein generating the dialogue output is responsive to determining that unusual activity is occurring.

16. The computer system of claim 9, wherein the generative AI model includes at least one of: (i) an AI or machine learning (ML) chatbot or (ii) an AI or ML voice bot.

17. A tangible, non-transitory computer-readable medium storing instructions for analyzing home telematics data that, when executed by one or more processors of a computing device, cause the computing device to:
receive home telematics data at a generative artificial intelligence (AI) model, wherein the home telematics data includes sensor data regarding a property associated with a user;
analyze, using the generative AI model, the home telematics data to generate a home telematics analysis for the property; and
generate, using the generative AI model, a dialogue output to present to the user based upon at least the home telematics analysis, wherein the dialogue output is further generated based upon at least a predicted user understanding of the dialogue output.

18. The tangible, non-transitory computer-readable medium of claim 17, the instructions further including instructions that, when executed, cause the computing device to:
determine, based upon at least the home telematics analysis, a likelihood of an insurance event occurring;
wherein the dialogue output includes at least one of (i) information related to the insurance event or (ii) one or more actions to address the insurance event.

19. The tangible, non-transitory computer-readable medium of claim 18, wherein the one or more actions include at least one of: (i) one or more preventative actions to prevent the insurance event, (ii) one or more mitigating actions to mitigate damage associated with the insurance event, or (iii) one or more prescriptive actions to fix damage associated with the insurance event.

20. The tangible, non-transitory computer-readable medium of claim 17, wherein analyzing the home telematics data includes:
determining a likelihood of user remembrance for one or more locations for sensor placement; and
wherein generating the dialogue output includes:
generating one or more recommendations for sensor placement based upon at least the determined likelihood of user remembrance.
